(19) United States
(12) Patent Application Publication
(10) Pub. No.: US 2019/0073661 A1
(43) Pub. Date: Mar. 7, 2019

(54) SYSTEMS AND METHODS FOR PROCESSING MOBILE TRANSACTIONS

(71) Applicant: SWAYPAY, INC., Foster City, CA (US)

(72) Inventors: Ahmet Sevket SEYALIOGLU, Redwood City, CA (US); Akbardzhon SALIEV, Foster City, CA (US)

(21) Appl. No.: 16/124,802

(22) Filed: Sep. 7, 2018

Related U.S. Application Data
(60) Provisional application No. 62/555,577, filed on Sep. 7, 2017.

(51) Int. Cl. G06Q 20/32; G06Q 20/40

(52) U.S. Cl. CPC G06Q 20/32; G06Q 20/401

(57) ABSTRACT

Systems and methods for providing secure, easy, and fast payment processing and confirmation are described herein.

### RELATED APPLICATIONS

This application claims priority under 35 U.S.C. § 119 to U.S. Provisional Patent Application No. 62/555,577, entitled “Systems and Methods for Processing Mobile Transactions,” filed Sep. 7, 2017, and which is incorporated herein by reference in its entirety as if set forth in full.

### BACKGROUND

### 1. Technical Field

The embodiments described herein are related to mobile transaction, and more specifically to secure, easy, and fast payment confirmation using a mobile device.

### 2. Related Art

It is well known that many online transactions are abandoned, costing retailers significant sums. According to one study in 2013, over 67% of online transactions are abandoned. The chart of FIG. 1 illustrates why online shoppers abandoned their purchases. While some of these reasons, i.e., cost too high, or just browsing, may be hard to overcome, others can be controlled. For example, website timeout, concerns about payment security, excessive payment security checks, process was too long, and web site navigation too complicated can all be linked in some way to the complication of website payment/checkout processes.

### SUMMARY

Systems and methods for providing secure, easy, and fast payment processing and confirmation are described herein.

These and other features, aspects, and embodiments are described below in the section entitled “Detailed Description.”

### BRIEF DESCRIPTION OF THE DRAWINGS

Features, aspects, and embodiments are described in conjunction with the attachments, in which:

FIG. 1 is a chart illustrating reasons consumers abandoned online transactions before completion;

FIGS. 2A-2H illustrate example web transaction processes according to one embodiment;

FIGS. 3A-3F illustrate an example mobile application transaction process according to one embodiment;

FIG. 4 illustrates account storage and encryption in accordance with one embodiment;

FIG. 5 illustrates a payment flow process in accordance with one embodiment; and

FIGS. 6-9 illustrate example registration processes in accordance with various example embodiments.

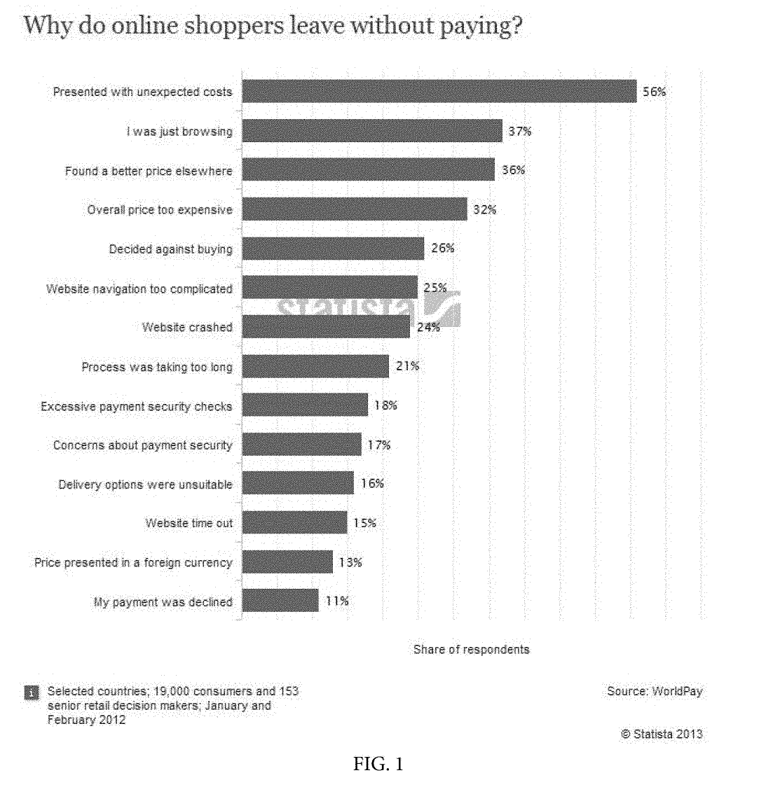

### DETAILED DESCRIPTION

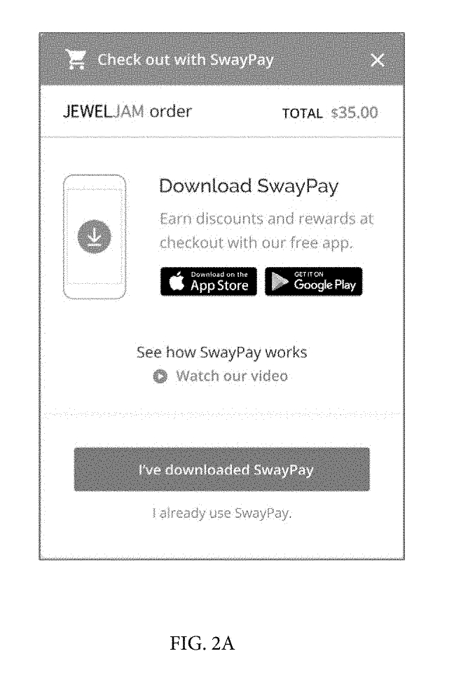

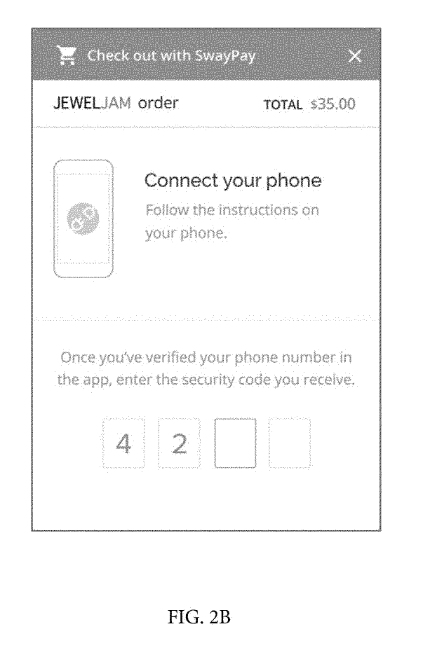

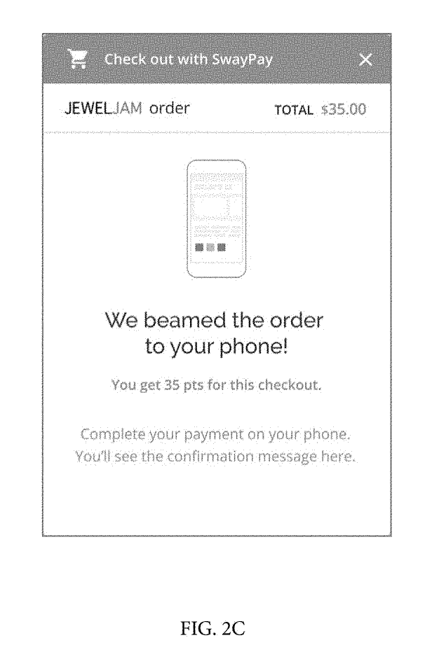

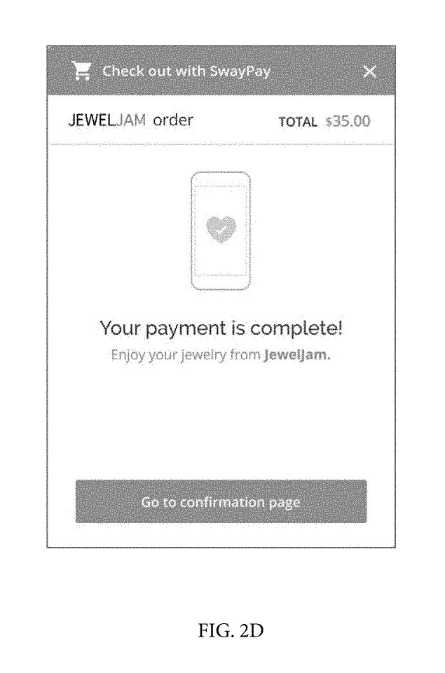

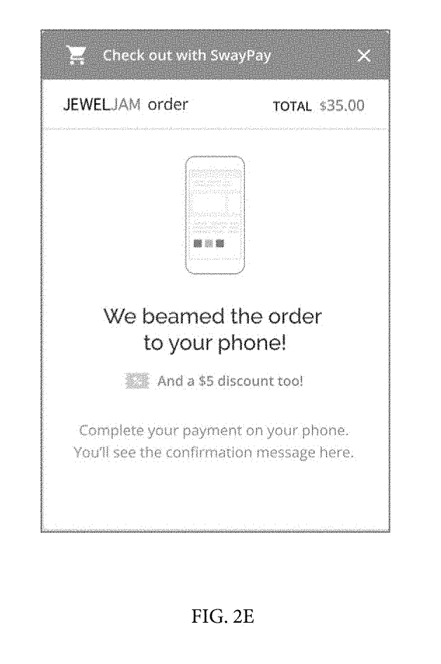

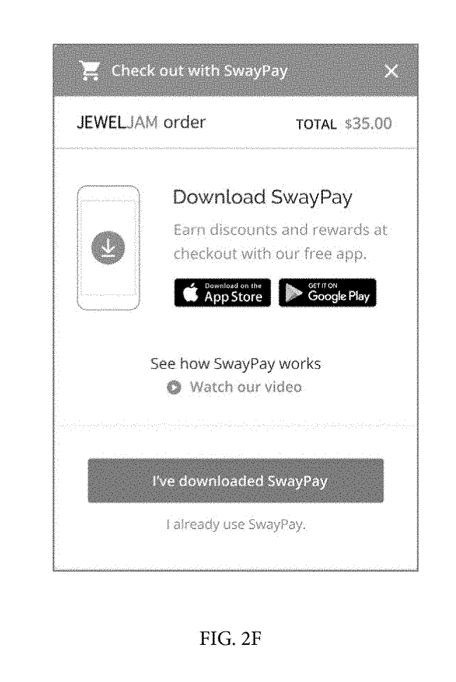

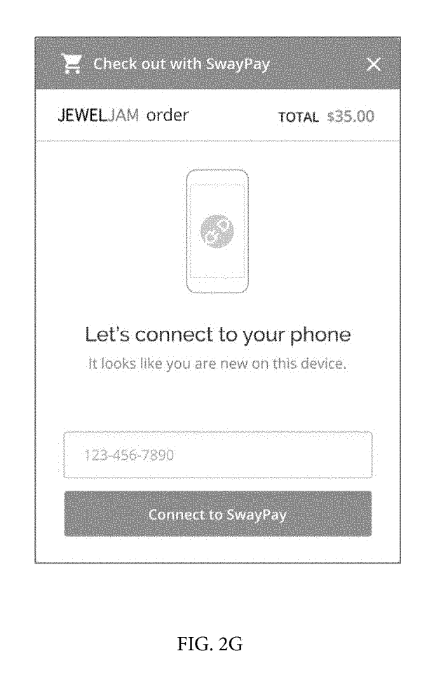

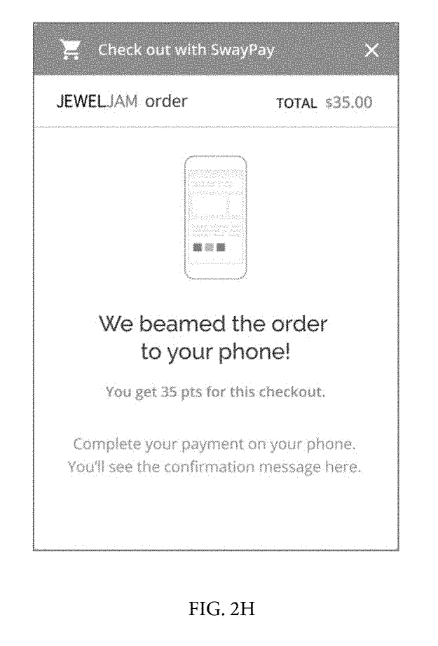

In the embodiments described herein, a user can download an application onto their mobile device, such as a smartphone or tablet. The application is then interfaced with a backend server and database that provides payment processing and security. When a user is browsing a website online and desires to make a purchase, they can select a payment option associated with the applications, such as the check our procedures illustrated in the screen shots of FIG. 2A-2H. First as illustrated in FIG. 2A, when the user is on a website and is ready to make a purchase, a button or other selection mechanism/method can be presented that offers the user the chance to pay using the systems and methods described herein. When the user elects to do so, by engaging or activating the selection mechanism presented, the user can download the application to a mobile device such as a smartphone or tablet. The user can also download the application to a laptop or desktop computer as illustrated below. But a mobile device with a cellular account will be require dot be connected in order to use the application to complete a transaction.

Once the application is downloaded, the user can then indicate such by pressing or activating a button or other input presented in the screen of FIG. 2A. The user would then need to login into the application in order to complete the transaction, or provide some indication of their account or mobile number to the website. The transaction information is then sent from the website to the associated mobile phone.

As illustrated in FIG. 2B, the user can connect their device they are using to make the purchase once they have provided their account or mobile number by first receiving a security code on that device, and then inputting, e.g., it into the screen illustrated in FIG. 2B. Now that the user's device, and the application loaded and running thereon is connected with the website on which the purchase is being made, the transaction details can be “beamed” to the user's device as illustrated in the example screen of FIG. 2C. The user can approve the transaction as illustrated in further screen shots presented below. But once that process is complete, the website on which the purchase is being made can present a screen, such as the example screen presented in FIG. 2D, confirming payment is complete.

As illustrated in FIG. 2E, if the user is already using the application and it is connected, then the website will simply beam the transaction information to the application on the users device, when they select the appropriate payment mechanism/method. The user can then complete the transaction as described above.

As illustrated in the example screen shots of FIGS. 2F-2H if the user has the application, but is using a different device than the associated mobile device, e.g., a laptop, then the user will need to connect their mobile device as well (FIG. 2G). The user can then complete the transaction using that mobile device as illustrated in FIG. 2H and as described above.

When the user registers their mobile device with the system, they can also associate a credit card or account. Alternatively, when the user confirms payment on their phone they can be asked to designate a card or mobile wallet to use for the transaction.

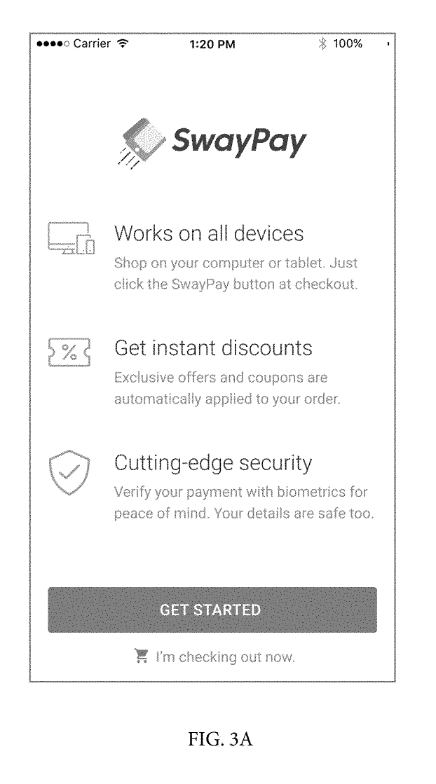

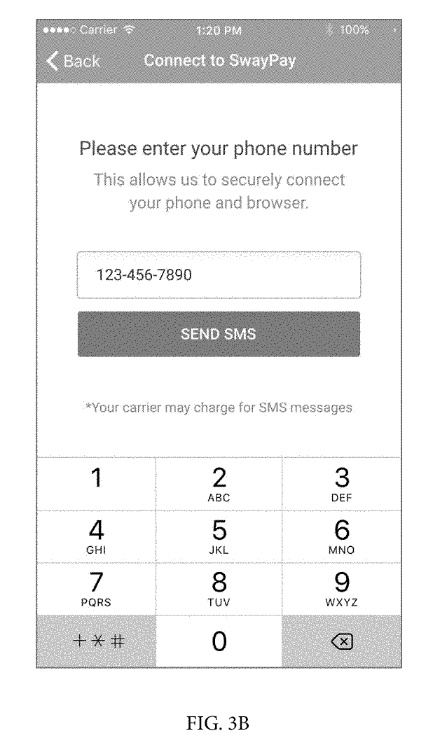

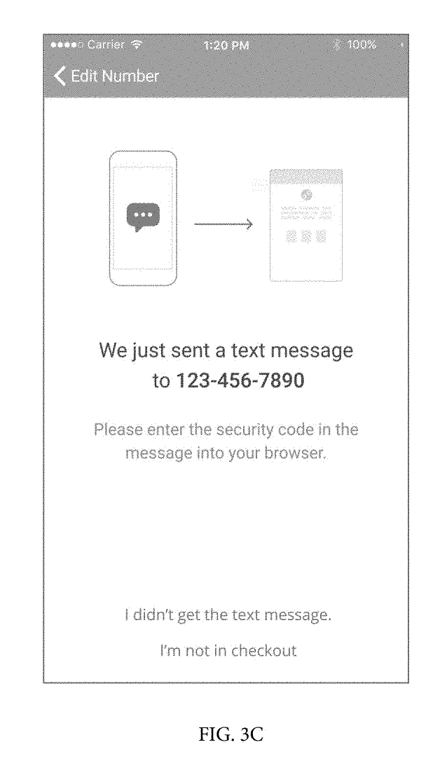

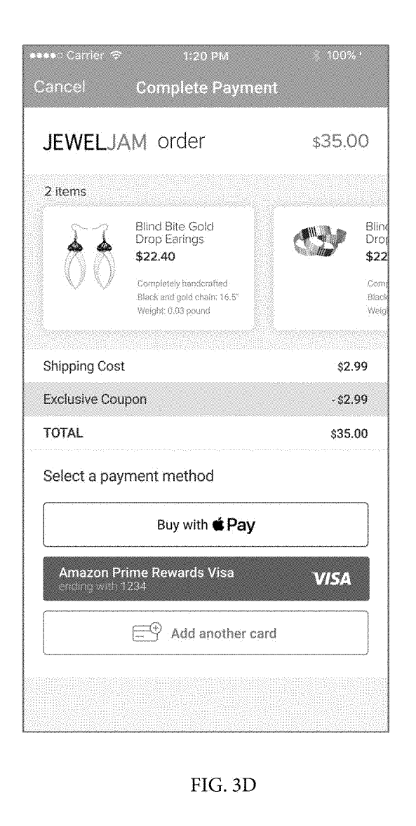

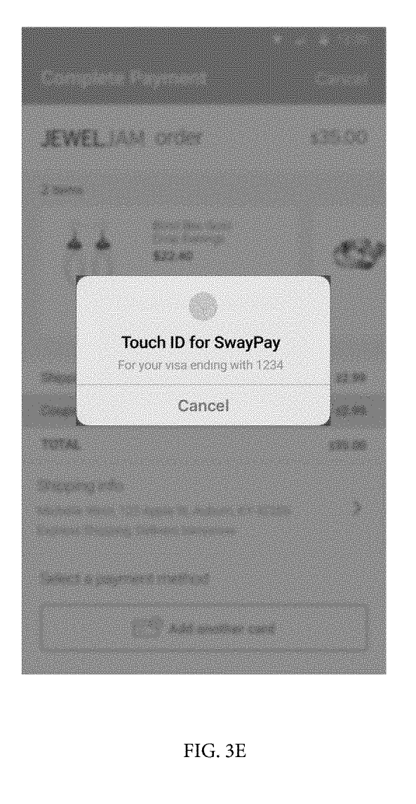

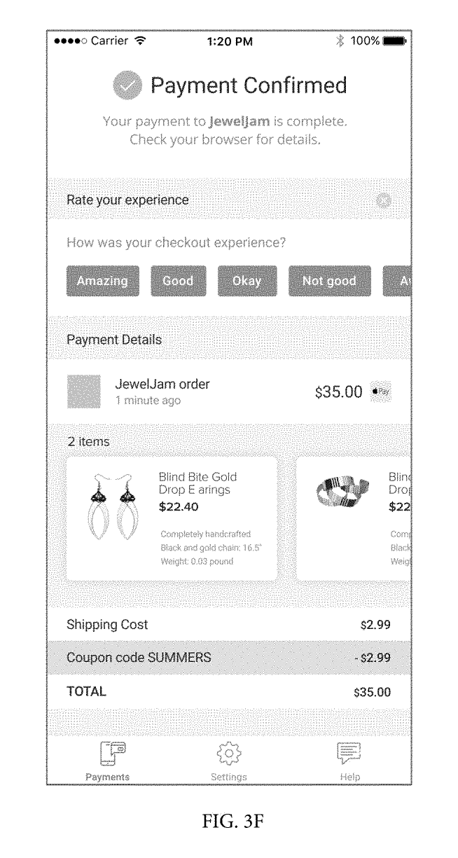

Not only is this process easy and efficient, it is also secure. As can be seen in FIGS. 3A-3F, the user can be required provide a credential to approve the transaction such as a PIN, biometric, or some combination thereof. But in addition, the account information is never stored in one location as described below. First, with respect to the process of FIGS. 3A-3F, it can be seen in the example screen of FIG. 3A that when the user selects to check out on their device, they are asked to connect their mobile device, whether the user was initially using that device at this point or not as described above, in order to complete the transaction (FIG. 3B). A text will then be sent to that mobile device with a security code as illustrated in FIG. 3C.

As illustrated in FIG. 3D, once the user has entered the security code back into the application, the transaction details will be presented and the user can select a payment method. This payment method can be the credit card the user entered when they registered or some other payment method as illustrated.

As illustrated in FIG. 3E, the user can be required to input a credential such as a biometric or PIN for authentication. Once the credential is authenticated, the transaction can be completed and payment confirmed as illustrated in FIG. 3F.

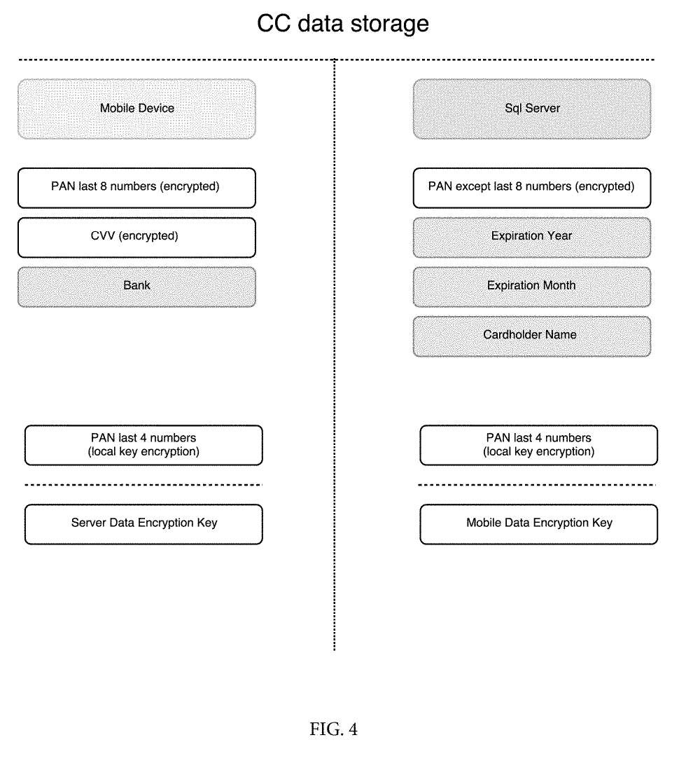

As noted above, the account information is never kept in one place. One embodiment for storing account information in accordance with the systems and methods described herein is illustrated in FIG. 4. The left side of FIG. 4 illustrates the account information stored on the user's mobile device, while the right side illustrates the information stored on a back end server. As can be seen, only the last half or portion of the account information is stored on the device, while the rest can be stored on the server. Thus, the account number can be encrypted and stored on the mobile, while part is encrypted and stored on the server. When a transaction is approved, the mobile portion can be sent to the server, where it can be decrypted and combined with the portion stored on the server. Importantly the key used to decrypt the information can require or comprise a local key and a key from either the mobile or server as illustrated. Thus, if the data being transmitted from the mobile is intercepted, it cannot be decrypted and even if it could be, it would not be the full account information or number.

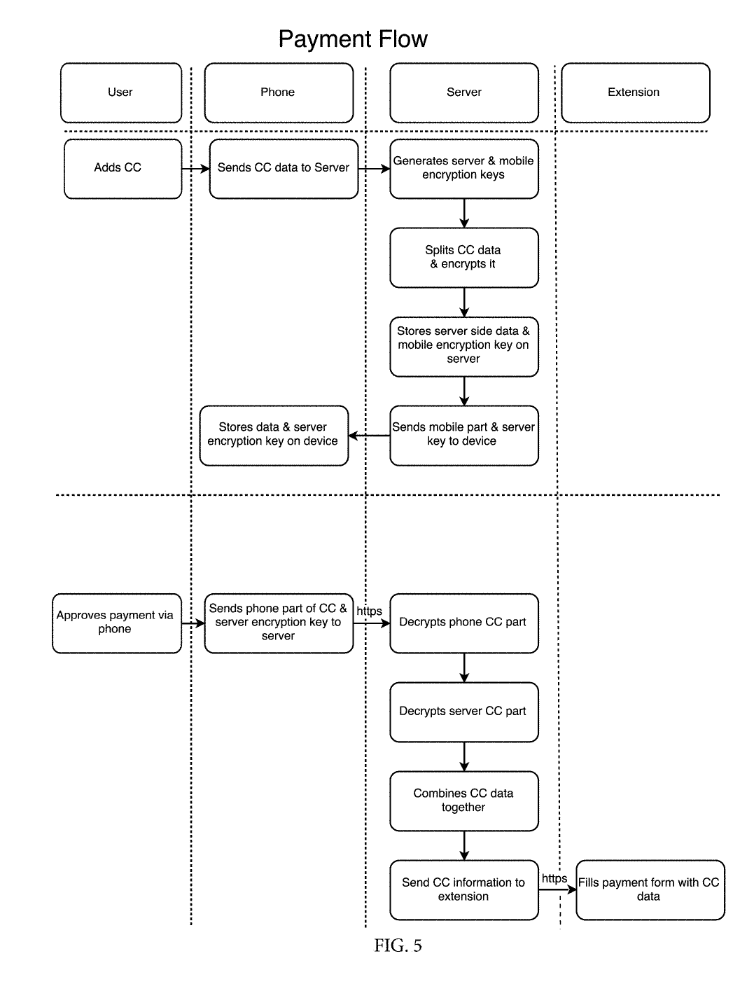

FIG. 5 illustrates the payment flow including encryption and decryption of data.

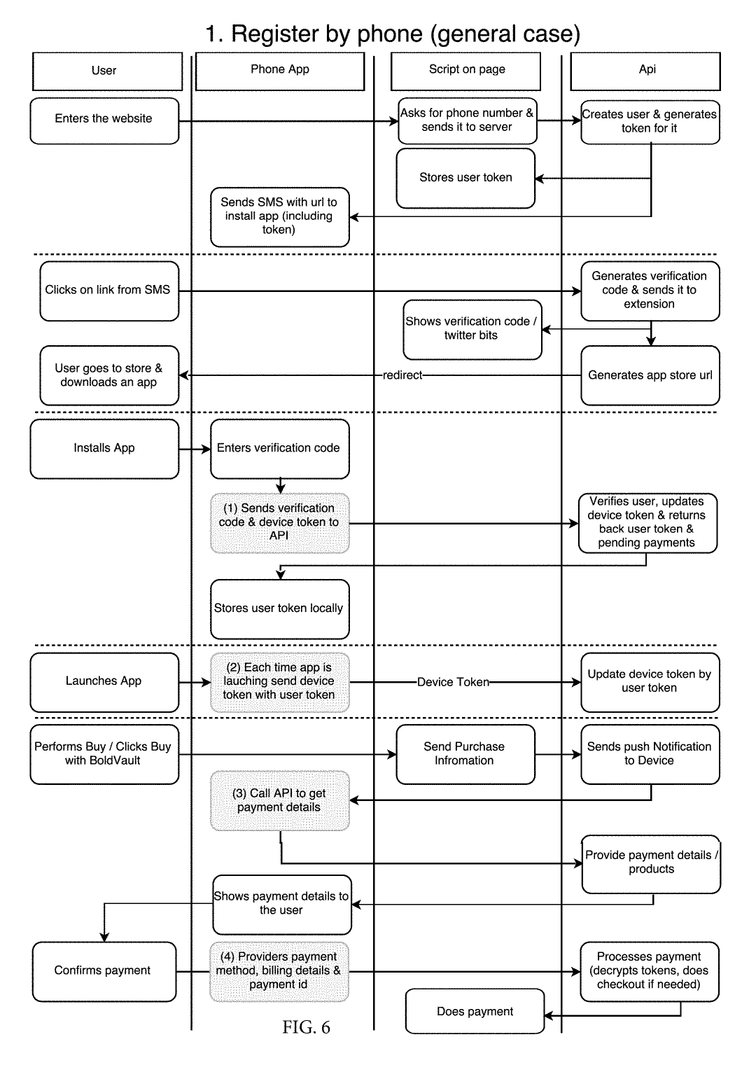

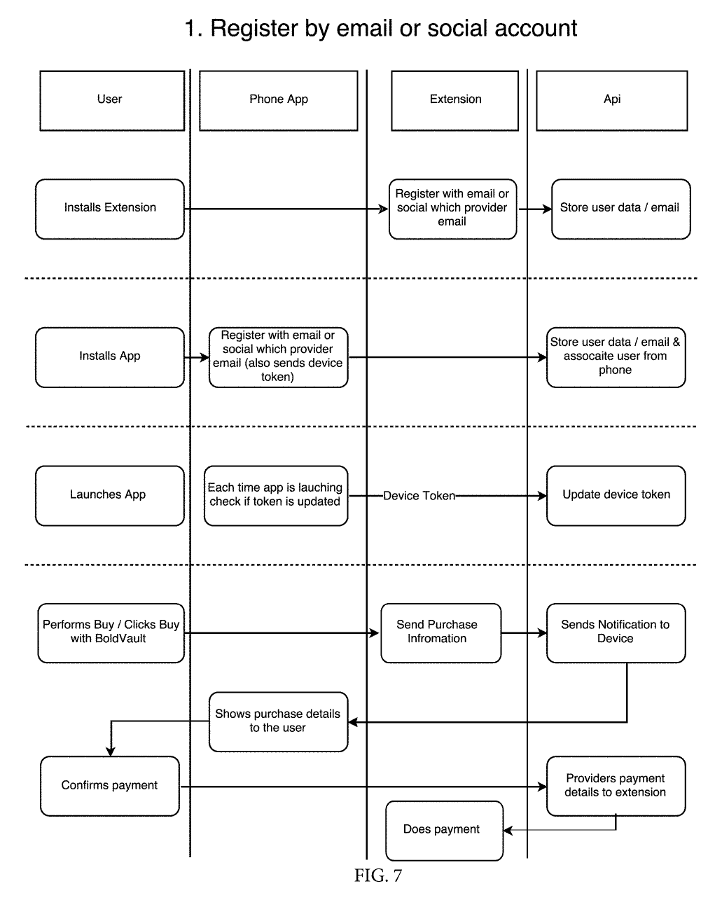

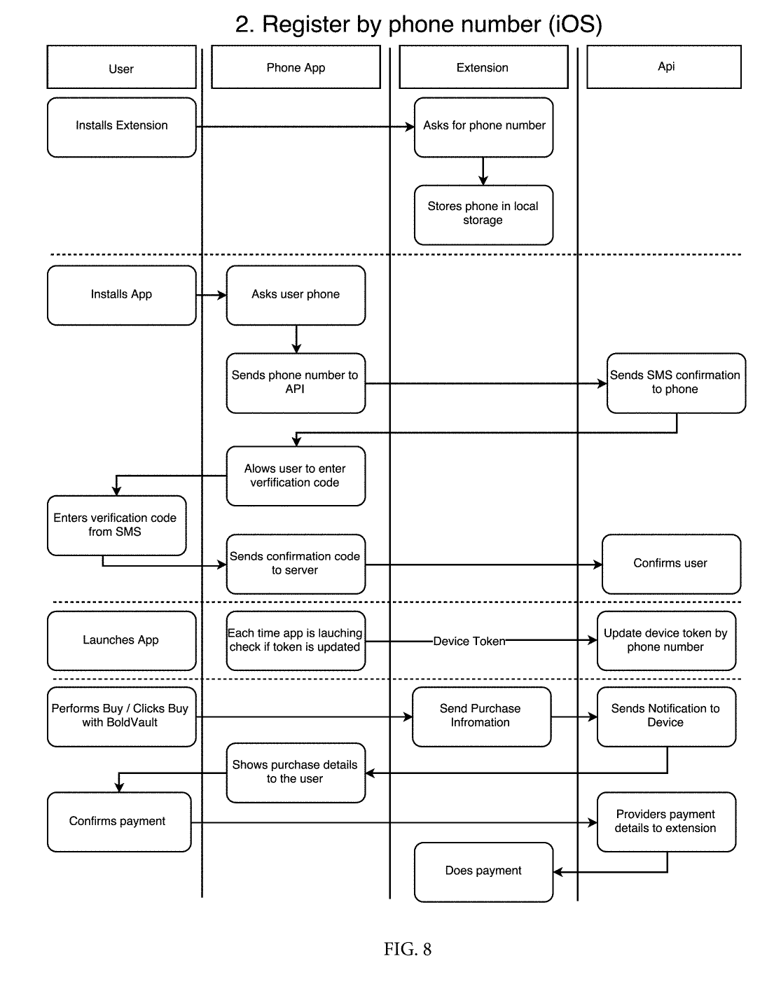

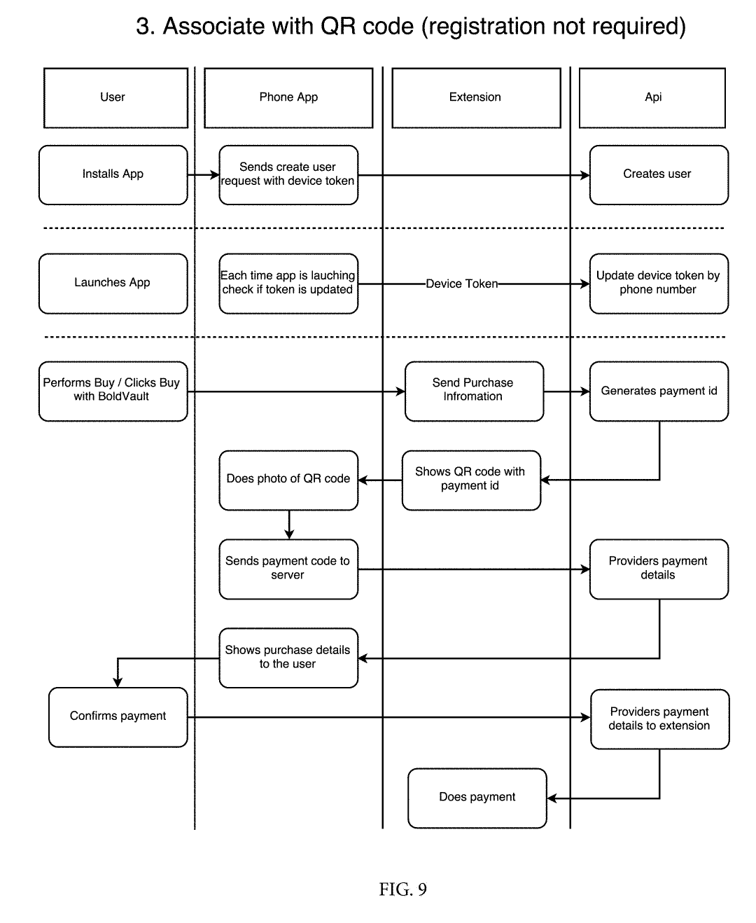

FIGS. 6-9 illustrate various processes for registering a device with the system.

While certain embodiments have been described above, it will be understood that the embodiments described are by way of example only. Accordingly, the systems and methods described herein should not be limited based on the described embodiments. Rather, the systems and methods described herein should only be limited in light of the claims that follow when taken in conjunction with the above description and accompanying drawings.

What is claimed:

1. A system comprising:
a mobile device comprising a transaction application;
a server comprising a back end processing system;
a database configured to store account information, the system configured to approve and process a transaction in accordance with the above description and attachments.
